(19) United States
(12) Patent Application Publication
(10) Pub. No.: US 2009/0150706 A1
(43) Pub. Date: Jun. 11, 2009

(54) WRAPPER CIRCUIT FOR GLOBALLY ASYNCHRONOUS LOCALLY SYNCHRONOUS SYSTEM AND METHOD FOR OPERATING THE SAME

(76) Inventors: Myeong-Hoon OH, DaeJeon (KR); Seong-Woon Kim, DaeJeon (KR); Myung-Joon Kim, DaeJeon (KR); Sung-Nam Kim, DaeJeon (KR)

Correspondence Address: STAAS & HALSEY LLP, SUITE 700, 1201 NEW YORK AVENUE, N.W., WASHINGTON, DC, 20005, US

(21) Appl. No.: 12/186,114

(22) Filed: Aug. 5, 2008

(30) Foreign Application Priority Data
Dec. 11, 2007 (KR) 10-2007-128544

(51) Int. Cl. G06F 1/12; H04L 7/00

(52) U.S. Cl. 713/400; 375/354

(57) ABSTRACT

Provided are a high-performance wrapper circuit for a globally asynchronous locally synchronous (GALS) system and a synchronization method using the same, which are capable of solving a synchronization problem caused when data are transmitted between locally synchronous modules employing different clocks, and a method for operating the wrapper circuit. The GALS system includes a clock generator for supplying an operation clock to a locally synchronous module, a sender port for transmitting data to the outside according to a data transmission request signal output from the locally synchronous module, and generating a first clock stop signal for stopping an operation of the clock generator, and a receiver port for receiving data from the outside, and generating a second clock stop signal for stopping the operation of the clock generator. The sender port generates the first clock stop signal to the clock generator when a next data transmission request signal is received before completing a data transmission performed by a previous data transmission request signal output from the locally synchronous module.

### CROSS-REFERENCE TO RELATED APPLICATIONS

This application claims priority under 35 U.S.C. §119 to Korean Patent Application No. 10-2007-128544, filed on Dec. 11, 2007, the disclosure of which is incorporated herein by reference in its entirety.

### BACKGROUND OF THE INVENTION

1. Field of the Invention

The present disclosure relates to a globally asynchronous locally synchronous (GALS) system, and more particularly, to a wrapper circuit for a GALS system, which is capable of solving a synchronization problem caused when data are transmitted between locally synchronous modules employing different clocks, and a method for operating the wrapper circuit.

2. Description of the Related Art

Generally, when an intellectual property (IP) based System on Chip (SoC) is designed using a typical synchronous design technique using a global clock, clock skew and jitter problems caused by the increase of a clock rate should be solved and power consumption for clock distribution will be increased. In addition, the IP based SoC should be designed considering a delay time of a transmission line, which is relatively longer than a delay time of components. The design time is increased by the difference of clock frequencies between IPs, which makes it difficult to quickly cope with market demands. Meanwhile, an asynchronous design technique may be proposed as an approach to solving the above problems because it does not use the global clock and the data transmission is performed using a handshake protocol having no relation to delay time. However, when a scale of an asynchronous circuit part increases, a design complexity increases and a testing also becomes difficult. In addition, an asynchronous CAD tool supporting the design is insufficient.

A GALS system has been proposed as an approach that can overcome the disadvantages of the asynchronous design technique and fundamentally solve the problems of the synchronous design technique on the architecture.

Such a GALS system performs the data transmission between a plurality of heterogeneous synchronous IPs operating with different clocks using an asynchronous handshake protocol instead of a global clock. The GALS system is characterized in that it has both the advantage of a global clock based synchronous circuit design technique and the advantage of an asynchronous circuit design technique. However, the data transmission between modules is performed through a specified wrapper circuit by the asynchronous handshake protocol.

The GALS system does not use a single global clock and includes a plurality of small-sized locally synchronous modules operating with independent clocks. The locally synchronous modules are designed using an existing synchronous CAD tool and verification method.

A wrapping circuit is essential to the GALS system. The wrapping circuit solves a problem of synchronization between locally synchronous modules in data transmission between the locally synchronous modules operating with different operating frequencies, and generates an asynchronous handshake protocol.

That is, since all data are transmitted through the wrapping circuit, the performance of the wrapping circuit directly affects the entire system performance. The implementation of an efficient GALS system requires a high-performance wrapping circuit. A synchronization method, which is an important function of the wrapping circuit, may be classified into a method for controlling a data line and a method for controlling a clock line.

The method for controlling the data lines may use a synchronization device that serially connects two or more storages. Data having a metastable state are stabilized after a predetermined time elapses. By serially connecting a latch to a data line, a time taken to sample data using a clock increases. Thus, the stabilized data can be stored. This method is easy to implement and can significantly reduce a synchronization failure probability, but it cannot perfectly ensure the synchronization of transmission data and increases a latency of data as the synchronization failure rate is lowered.

As a more fundamental solution, a synchronization method has been proposed which performs a synchronization by generating a pausable clock when a metastable state occurs between an input signal and an internal clock, while controlling a clock line based on a ring oscillation scheme. This method may be classified into two methods.

First, a synchronization method using a pausable clock recognizes data by sampling a request signal (req) and an acknowledge signal (ack) of a handshake protocol with an internal clock. This method is widely used when a handshake protocol is needed in a synchronous design technique, which is based on a global clock and has a variable clock cycle. An external control signal (a request signal or an acknowledge signal) cannot be predicted at a next cycle of an internal clock, but can be known at a next cycle by sampling. This synchronization method is referred to as a unknown next value (UNV) method. Unlike in the synchronous circuit, the UNV method is implemented using a mutual exclusion (ME) element, which is well tuned at a lower level, or a specified circuit, which can detect a metastable state, in order to resolve a metastable state occurring between an internal clock and an external handshake protocol. Upon transmission of external data, an internal clock must be always generated in order to recognize a start time and an end time of the data transmission. Therefore, the UNV method has a great disadvantage in view of power consumption.

Second, a synchronization method using a pausable clock completely stops an internal clock while a handshake protocol is in progress.

A data transmitter can avoid a metastable state between a clock and an acknowledge signal by generating a request signal, stopping a clock simultaneously, and regenerating a clock when an external handshake protocol is finished.

A data receiver generates a clock in a clock idle state in response to a request signal output from the data transmitter, and waits for a next data by stopping the clock when an internal operation is finished. This method maintains the clock in an idle state during data transmission, and regenerates the clock after the data transmission protocol is finished and data is stored. In this way, this method can theoretically avoid the metastable state rather than solve the metastable state. In both the data transmitter and the data receiver, a next clock cycle after the clock idle state is in a state where the handshake protocol is finished. This method is referred to as a known next value (KNV) method because states of the control signals (the request signal and the acknowledge signal) can be always predictable.

In the KNV method, when an operation of the data receiver is finished, the data receiver maintains the clock in the idle state until the next data transmission, and the data transmitter stops the clock while waiting the response signal, thus preventing unnecessary power consumption. However, if the response time of the data receiver is lengthened, the data transmitter must stop the clock as much as the lengthened response time. Hence, the entire system performance may be degraded because the internal operation of the locally synchronous module and the data transmission are not performed in parallel.

### SUMMARY

Therefore, an object of the present invention is to provide a wrapper circuit for a GALS system, which is capable of solving a synchronization problem caused when data are transmitted between locally synchronous modules using different clocks, and a method for operating the GALS system.

Another object of the present invention is to provide a wrapper circuit for a GALS system, which is capable of increasing a processing speed by performing in parallel an external handshake operation for data transmission and reception and an internal operation, and a method for operating the wrapper circuit.

To achieve these and other advantages and in accordance with the purpose(s) of the present invention as embodied and broadly described herein, a wrapper circuit for a GALS system in accordance with an aspect of the present invention includes: a clock generator for supplying an operation clock to a locally synchronous module; a sender port for transmitting data to the outside according to a data transmission request signal output from the locally synchronous module, and generating a first clock stop signal for stopping an operation of the clock generator; and a receiver port for receiving data from the outside, and generating a second clock stop signal for stopping the operation of the clock generator, wherein the sender port generates the first clock stop signal to the clock generator when a next data transmission request signal is received before completing a data transmission performed by a previous data transmission request signal output from the locally synchronous module.

To achieve these and other advantages and in accordance with the purpose(s) of the present invention, a GALS system in accordance with another aspect of the present invention includes: a plurality of locally synchronous modules that are mutually asynchronous; a plurality of wrapper circuits, connected to the respective locally synchronous modules, for performing data transmission/reception between the respective locally synchronous modules, and controlling a clock generator for generate a clock to the respectively locally synchronous modules, wherein the wrapper circuit permits the data transmission of the locally synchronous module and an internal operation to be performed at the same time, and the wrapper circuit temporarily pauses the operation of the locally synchronous module by stopping the operation of the clock generator when the locally synchronous module requests a next data transmission while the data is being transmitted.

To achieve these and other advantages and in accordance with the purpose(s) of the present invention, a method for operating a wrapper circuit for a GALS system having a clock generator for supplying a clock to a locally synchronous module GALS system in accordance with another aspect of the present invention includes: stopping or resuming an operation of the clock generator according to an operation state of the locally synchronous module when a data transmission request signal is received from the locally synchronous module; and stopping the operation of the clock generator when a data reception request signal is received from the locally synchronous module.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a waveform diagram illustrating a data transmission scheme of a wrapper circuit in a GALS system according to an embodiment of the present invention;

FIG. 2 is a block diagram of a wrapper circuit for the GALS system according to an embodiment of the present invention;

FIG. 3 is an exemplary view for explaining the operation of a sender port of FIG. 2;

FIG. 4 is a block diagram illustrating an internal structure of a decoupled sender port having a 4-case-arbiter;

FIG. 5 is an exemplary view illustrating an Asynchronous Finite State Machine (AFSM) of a first input signal unit of FIG. 4;

FIG. 6 is an exemplary view illustrating an AFSM of a control unit of FIG. 4;

FIG. 7 is an exemplary view illustrating an AFSM of a receiver port of FIG. 2;

FIG. 8 is a circuit diagram illustrating an internal structure of a clock generator of FIG. 2; and

FIG. 9 is a circuit diagram of a digitally controlled oscillator (DCO) of FIG. 8.

### DETAILED DESCRIPTION OF EMBODIMENTS

A wrapper circuit according to the present invention adopts a pausable clock scheme that controls an internal clock in order to fundamentally solve the synchronous failure problem. In order to solve a parallel-processing failure problem caused by the dependency of an external handshake protocol and an internal operation of a locally synchronous (LS) module, the present invention provides a data transmission mechanism that partially decouples an internal clock and an external handshake protocol.

Furthermore, a technical feature of the present invention is that the wrapper circuit generates an internal clock using a digitally controlled oscillator (DCO) in order to reduce circuit area and power consumption and facilitate the generation of a desired clock.

Hereinafter, specific embodiments will be described in detail with reference to the accompanying drawings. The following description will be focused on portions necessary to understand the operation and effect of the present invention.

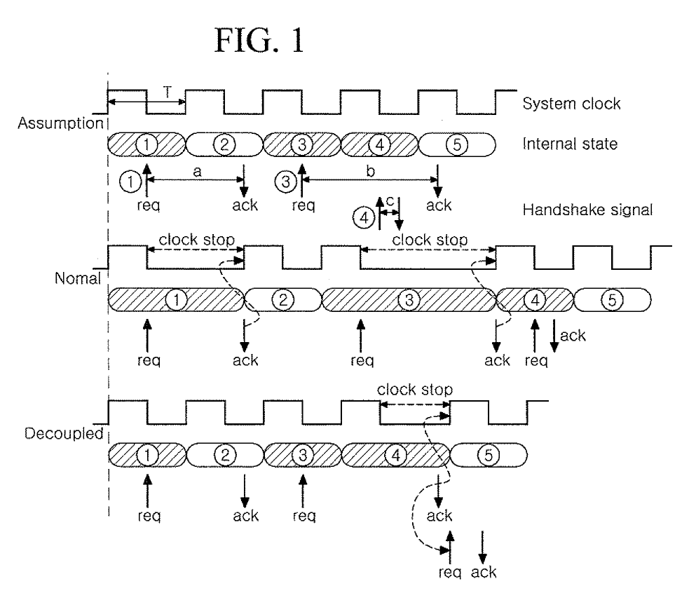

FIG. 1 is a waveform diagram illustrating a data transmission scheme of a wrapper circuit in a GALS system according to an embodiment of the present invention. Specifically, FIG. 1 illustrates an example of a data transmission mechanism based on a pausable clock in a sender of an LS module using a system clock having a period of T.

It is assumed herein that the sender requests data transmission at internal cycles (internal states) \textcircled{1}, \textcircled{3} and \textcircled{4} and performs an internal operation independently of the data transmission at internal cycles \textcircled{2} and \textcircled{5}. In addition, reference symbols “a”, “b” and “c” represent handshake protocol latencies required to transmit three data, respectively. A reference symbol “req” is a start point of a 4-phase handshake, which is synchronized with a time point when a system clock changes from a high level to a low level. A reference symbol “ack” represents a data transmission completion and is generated independently of the system clock because it is received from an external other LS module.

A normal data transmission scheme is a synchronization scheme using a typical KNV method. The clock is stopped when an internal cycle of the sender is in a transmission state, and it is maintained in an idle state until the data transmission is completed. When the data transmission is completed, the clock is regenerated and a next cycle operation is performed.

Like the data transmission of the internal cycle \textcircled{4}, when the data transmission in one clock is completed, the clock maintains the original period. However, like the internal cycle \textcircled{2}, when the next state is independent of the data transmission after the data transmission state, the clock need not be stopped until the handshake protocol is completed.

According to the decoupled data transmission scheme proposed in the present invention, the internal operation in the internal state \textcircled{2} of the LS module can be performed in parallel with the handshake protocol required to transmit the external data.

That is, the clock is not unconditionally stopped whenever the data transmission is requested. Like the decoupled internal cycle \textcircled{4}, the clock is stopped when the internal cycle again becomes the data transmission state in such a state that the previous handshake protocol is not finished (a protocol latency generated in the internal cycle \textcircled{3}). Then, after the previous handshake protocol is finished, the data transmission is enabled and the clock is regenerated.

The time necessary to perform the five cycles is “4T+a+b” in the normal data transmission and “3.5T+b” in the decoupled data transmission. In the normal data transmission, the necessary time includes the latencies of each transmitted data. However, the decoupled data transmission has a faster end time because each data transmission is performed in parallel with the internal clock, that is, the internal operation.

The wrapper circuit according to an embodiment of the present invention uses a 4-phase bundled data protocol in order for easy communication without modifying latches or flip-flops used in the LS module. In addition, an active-out-passive-input type push channel widely used in the asynchronous circuit design is assumed herein. The 4-phase bundled data protocol will be described later in detailed.

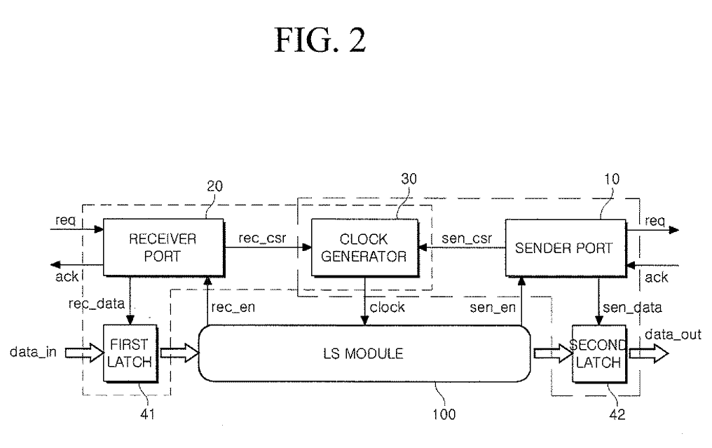

FIG. 2 is a block diagram of the wrapper circuit for the GALS system according to an embodiment of the present invention.

Referring to FIG. 2, the wrapper circuit includes a sender port 10 for transmitting an output data, a receiver port 20 for receiving an input data, a clock generator 30 for generating a system clock to the LS module 100, a first latch 41 for latching a data data_in input by the data of the receiver port 20 and transmitting the latched data data_in to the LS module 100, and a second latch 42 for latching a data data_out output from the LS module 100 and transmitting the output data of the LS module 100 by the data of the sender port 10.

Each of the ports processes the external handshake protocol signal and generates a control signal that can stop the clock. The entire operation of the wrapper circuit can be summarized as follows.

The clock generator 30 generates the clock to operate the LS module 100.

The sender port 10 receives an enable signal rec_en from the LS module 100 and is informed of a data input timing of the LS module 100, and the receiver 20 receives an enable signal sen_en from the LS module 100 and is informed of a data output timing of the LS module 100. The enable signals rec_en and sen_en have a meaning at both a high level and a low level.

The input data storage time point of the first latch 41 is determined by the enable signal of the LS module 100.

The sender port 10 processes the handshake protocol control signals req and ack and, in some cases, generates a sender clock stop request signal sen_csr for stopping the clock. The receiver port 20 processes the handshake control signals req and ack and, in some cases, generates a clock stop request signal rec_csr for stopping the clock.

When the clock generator 30 receives the clock stop request signal rec_csr or sen_csr, it stops generating the clock until the time point at which the external data transmission is completed (the time point at which the handshake. protocol is finished), that is, until the clock stop request signals rec_csr and sen_csr again become inactive.

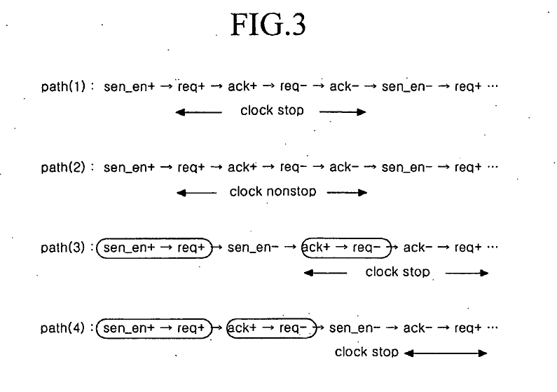

In the sender port 10, the wrapper circuit using the typical KNV method maintains a signal generation order like a path (1) of FIG. 3, and the clock maintains the idle state after the data enable signal is generated. However, the decoupled wrapper circuit does not stop the clock even though the enable signal sen_en is changed.

In other words, after an event sen_en+ or sen_en− is generated, the generation of another event sen_en− or sen_en+ is permitted while the handshake protocol is in progress. Consequently, the decoupled sender port 10 sequentially generates signals in one of a path (2), a path (3), and a path (4).

The path (2) represents a case where another data transmission is started by the event sen_en− after the data transmission due to the event sen_en+ is finished. In this case, unlike the path (1) using the typical KNV method, the degradation of performance can be prevented because the clock is not stopped.

If the LS module 100 requests another data transmission using the event sen_en− even though the data transmission due to the event sen_en+ is not finished, the clock is stopped until the generation of an event ack− representing the completion of the previous data transmission, like the paths (3) and (4). After the event ack− is recognized, the clock is regenerated and the data transmission is performed by the event req+ at the same time.

It will be assumed that, in the path (2), the event sen_en− may be generated between four signal pairs, that is, (sen_en+, req+ ), (req+, ack+), (ack+, req−), and (req−, ack−), but the event sen_en− generated in (sen_en+, req+) and (ack+, req−) is delayed after the control signal req as indicated in the paths (3) and (4). In practice, the design complexity can be removed by this assumption, and this assumption can be sufficiently satisfied in the design.

In the decoupled sender port 10, the input signals ack and sen_en are independently generated. When multiple input signals are simultaneously generated in the asynchronous circuit, it is important to determine the order of the signals. In particular, it is very important to determine the order of the signals ack and sen_en because whether to stop the internal clock is determined according to which one of the control signal ack and the subsequent enable signal sen_en is first generated after the previous enable signal sen_en is generated.

To this end, an arbiter circuit must be used. The arbiter circuit must be able to distinguish four signal pairs (sen_en+, ack+), (sen_en+, ack−), (sen_en−, ack+) and (sen_en−, ack−).

The sender port 10 of the wrapper circuit according to the present invention uses a new 4-case-arbiter different from the typical arbiter.

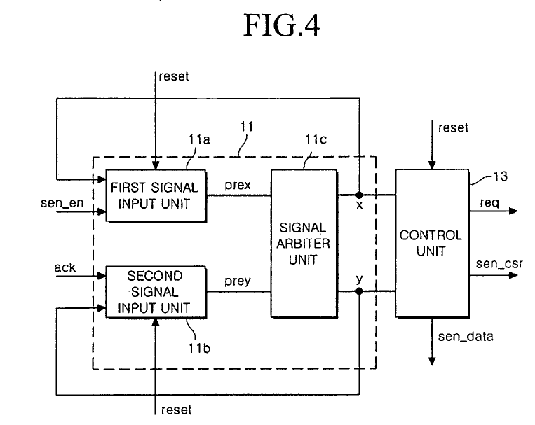

FIG. 4 is a block diagram illustrating an internal structure of a decoupled sender port having a 4-case-arbiter.

Referring to FIG. 4, the 4-case-arbiter 11 includes a first signal input unit 11a, a second signal input unit 11b, and a signal arbiter unit 11c.

The first signal input unit 11a receives the enable signal sen_en of the sender port 10 to generate a logic value “1” signal according to an output signal x of the signal arbiter unit 11c.

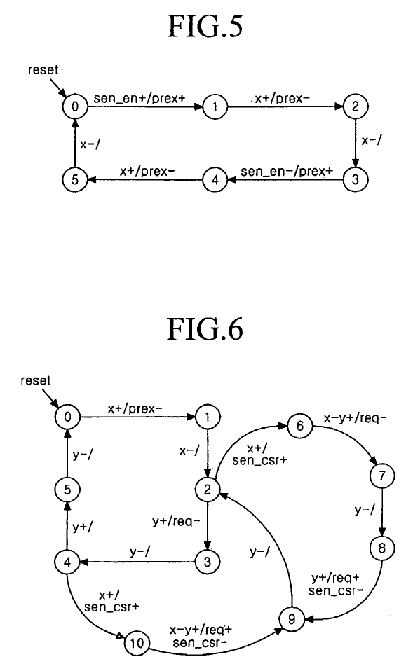

The second signal input unit 11b receives the control signal ack to generate a logic value “1” signal according to an output signal y of the signal arbiter 11c. The first and second signal input units 11a and 11b perform the same operation. The first and second signal input units 11a and 11b are described by an Asynchronous Finite State Machine (AFSM) of FIG. 5 and can be implemented using a known synthesis tool.

The first and second signal input units 11a and 11b and a control unit 13 are reset by a reset signal reset.

The signal arbiter unit 11c determines the order of voltage variation of the signals output from the first and second signal input units 11a and 11b, and outputs the corresponding signals x and y.

As described above, the control unit 13 performs the paths (2), (3) and (4) of FIG. 3 using the output signals x and y of the 4-case-arbiter 11, whose order is determined by distinguishing the variation of the high voltage and low voltage of the signals sen_en and ack.

As illustrated in FIG. 6, the control unit 13 can start the handshake protocol by generating the control signal req and stop the clock in a corresponding condition by generating the clock stop request signal sen_csr.

The following Table 1 shows the states of the control unit 13 according to the paths (2) through (4) of FIG. 3.

TABLE 1

| Path | State Transition |
|---|---|
| (2) | 0 → 1 → 2 → 3 → 4 → 5 → 0 |
| (3) | 0 → 1 → 2 → 6 → 7 → 8 → 9 |
| (4) | 0 → 1 → 2 → 3 → 4 → 10 → 9 |

The function of the receiver port 20 is similar to the typical KNV method.

That is, if a request to receive input data is input at a time point at which the LS module 10 requests the input data, the receiver port 20 stops the clock and performs the internal operation after the data is received.

A time point after the operation is finished is considered as a time point at which the input data can be received. Thus, the receiver port 20 stops the clock and waits the input data request.

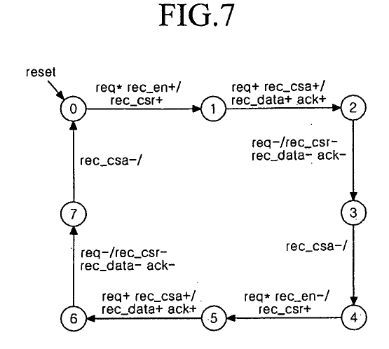

FIG. 7 illustrates an AFSM of the receiver port of FIG. 2.

When the enable signal rec_en is generated regardless of the control signal req, that is, the external request to receive the input data, the receiver port 20 stops the clock in response to the event rec_csr+. In order to meet the requirement that at least one input event should exist in the receiver port, a signal rec_csa that is a feedback signal of a clock stop request signal rec_csr is added.

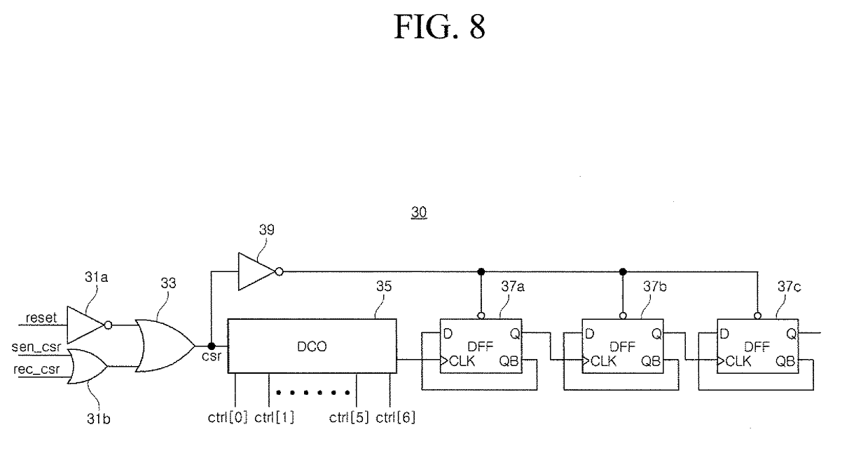

FIG. 8 is a circuit diagram illustrating an internal structure of the clock generator of FIG. 2.

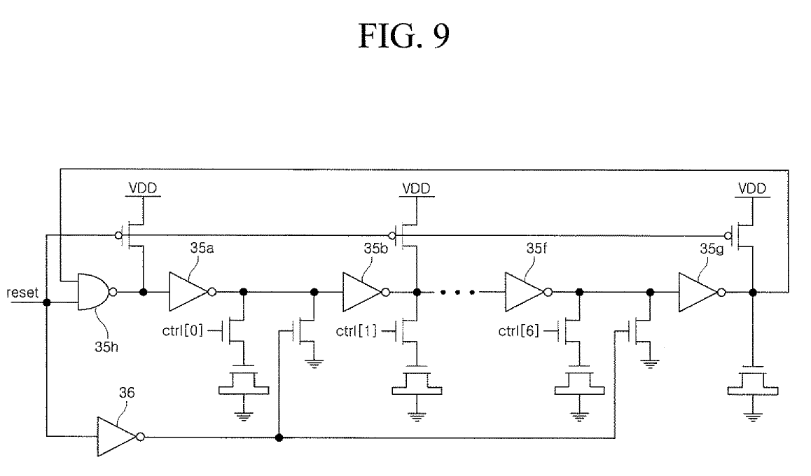

Referring to FIG. 8, the wrapper circuit requiring multiple ports, e.g., a plurality of sender ports and a plurality of receiver ports, receives a plurality of clock stop request signals csr from the sender ports and the receiver ports, and generates a final clock stoop request signal csr to the digitally controlled oscillator (DCO) 35 using an inverter 31a, a first OR gate 31b, and a second OR gate 31c. As illustrated in FIG. 9, in order to easily generate a variety of clock frequencies, the DCO 35 can change the clock frequency by controlling an internal delay time through on/off operation of control signals ctrl[0] through ctrl[6] of shunt capacitors in an internal structure including inverters 35a through 35g and a NAND gate 35h. In addition, the DCO 35 supports the function of preventing a clock oscillation in order to realize a pausable clock.

Then, the range of the generated frequency can be expanded by inputting the output of the DCO 35 as the clock signal of a first D flip-flop 37a and inputting an output signal Q of the first D flip-flop 37a as the clock signals of the second and third D flip-flops 37b and 37c. The clock stop request signal csr input to the DCO 35 is branched and input as a reset signal of the first to third D flip-flops 37a through 37c through an inverter 39. The reset signal enables the output clock signal of the clock generator 30 to be selectively pausable.

A method for operating the wrapper circuit of the GALS system according to an embodiment of the present invention will be described below. The following description will be focused on the operation of the sender port 10 in the wrapper circuit of the GALS system.

When the sender port 10 receives the enable signal sen_en from the LS module 100, it stops or resumes the operation of the clock generator 30 according to the operation state of the LS module 100.

That is, when the sender port 10 receives the enable signal sen_en from the LS module 100, it determines whether or not the LS module 100 is transmitting data. In order to determine whether or not the LS module 100 is transferring the data, the wrapper circuit checks if the control signal ack is received from the outside with respect to the data transmission according to the enable signal sen_en. When the control signal ack is not received, the data is determined as being transmitted.

When the data is determined as not being transmitted, the sender port 10 maintains the operation of the clock generator 30 and transmits the data.

On the contrary, when the data is determined as being transmitted, the sender port 10 stops the operation of the clock generator 30 and waits the next data transmission.

When the sender port 10 receives the control signal ack from the outside, it transmits the next data of being waited.

When the control signal ack for the following data is received, the operation of the clock generator 30 is resumed.

When the sender port 10 receives the control signal req from the LS module 100, the operation of the clock generator 30 is stopped and then resumed after the data reception is completed.

Meanwhile, when the sender port 10 receives the control signal ack and the enable signal sen_en at the substantially same time, it determines one of the two signals as the received signal by detecting the rising and falling of the two signals, and performs the operation according to the determined signal.

The GALS system according to the present invention can solve the synchronization problem caused when data are transmitted between LS modules using different clocks, and can efficiently perform the handshake protocol. In particular, the performance of the wrapper circuit can be improved because the internal operation of the data transmitter and the external handshake operation can be performed in parallel partially. Due to the characteristics of the GALS system that performs the data transmission through the wrapper circuit, it can be expected that the improved performance of the wrapper circuit will lead to the improvement of the entire system performance.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A wrapper circuit for a globally asynchronous locally synchronous (GALS) system, comprising:
a clock generator for supplying an operation clock to a locally synchronous module;
a sender port for transmitting data to the outside according to a data transmission request signal output from the locally synchronous module, and generating a first clock stop signal for stopping an operation of the clock generator; and
a receiver port for receiving data from the outside, and generating a second clock stop signal for stopping the operation of the clock generator,
wherein the sender port generates the first clock stop signal to the clock generator when a next data transmission request signal is received before completing a data transmission performed by a previous data transmission request signal output from the locally synchronous module.

2. The wrapper circuit of claim 1, wherein the sender port resumes the operation of the clock generator by stopping the generation of the first clock stop signal when a data transmission completion signal is received from the outside while the operation of the clock generator is in a stopped state.

3. The wrapper circuit of claim 2, wherein the sender port comprises:
an arbiter unit for generating a control signal determined by a reception order of the data transmission request signal and the data transmission completion signal; and
a communication control unit for selecting one of a data reception request signal and the first clock stop signal according to the control signal output from the arbiter unit.

4. The wrapper circuit of claim 3, wherein when the data transmission request signal and the data transmission completion are received at the same time, the arbiter unit determines the arrival order of the data transmission request signal and the data transmission completion signal by detecting the rising and falling of the data transmission request signal and the data transmission completion signal.

5. The wrapper circuit of claim 3, wherein the arbiter unit generates a control signal for controlling the communication control unit to generate the first clock stop signal when a next data transmission request signal is received prior to the reception of the data transmission completion signal after the data transmission request signal is received, and
the arbiter unit generates a control signal for controlling the communication control unit to stop the generation of the first clock stop signal when the data transmission completion signal is received while the first clock stop signal is being output.

6. The wrapper circuit of claim 1, wherein the receiver port generates the second clock stop signal to the clock generator when a data reception request signal is received from the locally synchronous module, and
the receiver port stops the generation of the second clock stop signal after the data is received.

7. The wrapper circuit of claim 1, further comprising:
a first latch unit for latching data received from the outside, and transmitting the latched data to the locally synchronous module according to the control of the receiver port; and
a second latch unit for latching data received from the locally synchronous module, and outputting the latched data to the outside according to the control of the sender port.

8. The wrapper circuit of claim 1, wherein the clock generator comprises:
an OR gate for receiving at least one first clock stop signal and at least one second clock stop signal;
an oscillator for stopping the clock when there is an output of the OR gate; and
a plurality of D flip-flops connected in series to an output terminal of the oscillator.

9. The wrapper circuit of claim 8, wherein the oscillator is a digitally controlled oscillator (DCO) comprising a plurality of shunt capacitors and controlling a clock frequency by adjusting an internal delay time according to operation control signals of the respective shunt capacitors.

10. A globally asynchronous locally synchronous (GALS) system, comprising:
a plurality of locally synchronous modules that are mutually asynchronous;
a plurality of wrapper circuits, connected to the respective locally synchronous modules, for performing data transmission/reception between the respective locally synchronous modules, and controlling a clock generator for generate a clock to the respectively locally synchronous modules,
wherein the wrapper circuit permits the data transmission of the locally synchronous module and an internal operation to be performed at the same time, and the wrapper circuit temporarily pauses the operation of the locally synchronous module by stopping the operation of the clock generator when the locally synchronous module requests a next data transmission while the data is being transmitted.

11. The GALS system of claim 10, wherein the wrapper circuit pauses the operation of the locally synchronous module by stopping the operation of the clock generator when the locally synchronous module requests the data reception.

12. A method for operating a wrapper circuit for a globally asynchronous locally synchronous (GALS) system having a clock generator for supplying a clock to a locally synchronous module, the method comprising:
stopping or resuming an operation of the clock generator according to an operation state of the locally synchronous module when a data transmission request signal is received from the locally synchronous module; and
stopping the operation of the clock generator when a data reception request signal is received from the locally synchronous module.

13. The method of claim 12, wherein the stopping or resuming of the operation of the clock generator comprises:
determining whether the locally synchronous module is transmitting data, when the data transmission request signal is received from the locally synchronous module;
maintaining the operation of the clock generator and transmitting data when it is determined that the data is not being transmitted, and stopping the operation of the clock generator and waiting a next data transmission when it is determined that the data is being transmitted;
transmitting the next data of being waited, when a data transmission completion signal is received from the outside; and
resuming the operation of the clock generator when a data transmission completion signal for the next data is received.

14. The method of claim 13, wherein the determining of whether the data is being transmitted comprises:
checking whether a data transmission completion signal with respect to data transmission according to a previous data transmission request signal is received from the outside; and
determining that the data is being transmitted, when it is checked that the data transmission completion signal is not received.

15. The method of claim 14, further comprising determining the arrival order of the data transmission completion signal and the data transmission request signal of claim 13 by detecting the rising and falling of the data transmission completion signal and the data transmission request signal of claim 13 when the data transmission completion signal and the data transmission request signal of claim 13 are received at the same time.

16. The method of claim 12, wherein the stopping of the operation of the clock generator comprises resuming the operation of the clock generator after the data reception is completed.
